(19) United States
(12) Patent Application Publication
(10) Pub. No.: US 2005/0210163 A1
(43) Pub. Date: Sep. 22, 2005

(54) Memory control apparatus

(75) Inventors: Tomohiro Suzuki, Tokyo (JP); Yuji Tamura, Tokyo (JP); Tetsuya Ishikawa, Tokyo (JP); Hiroyasu Nishimura, Tokyo (JP); Tomoya Ogawa, Tokyo (JP); Fumikage Uchida, Asaka-shi (JP); Nao Moromizato, Tokyo (JP); Masayuki Yasukaga, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Konica Minolta Business Technologies, Inc., Tokyo (JP)

(21) Appl. No.: 10/946,524

(22) Filed: Sep. 21, 2004

(30) Foreign Application Priority Data
Mar. 18, 2004 (JP) JP2004-077571

(51) Int. Cl. G06F 13/28

(52) U.S. Cl. 710/22

(57) ABSTRACT

A memory control section 10 is arranged between a bus 3 and a memory 4, if there is access to a predetermined virtual address space from the bus side, a virtual memory space control section 13 gains the corresponding access to small-capacity FIFO memories 11 and 12 from a memory 4, the DMA controller 14 permits data transfer to be carried out between the FIFO memories 11 and 12 and memory 4, asynchronously with the access to the virtual address space from the bus 3 side, the leading addresses of the transfer destination and source inside the memory 4, and the size of the data to be transferred are presetting the DMA controller 14 from the CPU 2 and others on the side of the bus 3.

### TECHNICAL FIELD

The present invention relates to a memory control apparatus arranged between a bus and a memory.

### BACKGROUND

In a system using a bus as an information transmission path, various devices such as a memory 101 are directly connected to a bus 102 in normal cases, as shown in FIG. 4. The maximum read/write speed (memory processing capacity) that can be expected from a general memory, except for a special high-priced memory, is lower than the speed (data transfer capacity of a bus) at which such a device as a CPU exchanges data through a bus.

As shown in FIG. 5(a), assume, for example, that the data transfer capacity of the bus is X bytes per second, and the processing capacity of the memory is Y bytes per second. Also assume that the data transfer capacity of the bus (X bytes/second) is greater than the processing capacity of the memory (Y bytes/second).

In this case, if the amount of data to be transmitted is Z bytes, then the data transfer time required by the bus is Z/X seconds, and the data transfer time required by the memory is Z/Y seconds. Since the data transfer capacity of the bus (X bytes/second) is greater than the processing capacity of the memory (Y bytes/second), the data transfer time required by the memory (Z/Y seconds) is greater than the data transfer time required by the bus is Z/X seconds, as shown in FIG. 5(b). To put it another way, the memory processing capacity has been one of the factors determining the data transfer rate on the bus.

As described above, the access to the memory determines the data transfer rate on the bus. Accordingly, a technique has been proposed to improve the rate of transferring the data between the memory connected to the bus and I/O apparatus. This technique is intended to improve the processing speed when the data of the same value is transferred to a plurality of I/O apparatuses. The data scanned from the memory connected to the bus is stored in the internal memory, and transfer to each of the I/O apparatuses is carried out repeatedly from this internal memory (Official Gazette of Japanese Patent Tokkai 2000-105736, for example).

When access is made from the bus to the memory having the processing capacity lower than the data transfer capacity of the bus, a wait cycle 110 is inserted in the bus in order to fill the gap in the capacity, as shown in FIG. 6. As a result, the processing time for data transfer depends on the processing capacity of the memory. This results in a longer bus occupancy time for accessing the memory, hence a lower efficiency of bus utilization and a reduced throughput of the entire system.

Use of a special high-speed memory eliminates the need of inserting a wait cycle. However, this is not preferred because apparatus costs will be increased if a high-priced high-speed memory is used as a large-capacity memory for storing image data.

### SUMMARY

In view of the prior art described above, it is an object of the present invention to provide a memory control apparatus capable of turning a low-speed memory into a virtually high-speed memory.

The present invention relates to the memory control apparatus located between a bus and a memory. This memory control apparatus containing buffer memories (11, 12) having a higher speed and smaller capacity than the memory, a virtual memory space control section (13) for converting the access to a predetermined virtual address from the bus, into the access to the buffer memories (11, 12), and a data transfer section (14) for transferring data between the buffer memories (11, 12) and the memory, asynchronously with the access to the virtual address space.

According to the invention, when access is made from the bus to the virtual space to write or read the data, this access is made to the buffer memories (11, 12). This arrangement allows data read/write operation with respect to the virtual space to be performed from the bus at the speed conforming to the processing capacity of the buffer memories (11, 12).

In the meantime, the data transfer section (14) transfers data between the buffer memories (11, 12) and external memory, asynchronously with the access to the virtual address space from the bus. Data transfer between the buffer memories (11, 12) and external memory is carried out at the speed conforming to the processing capacity of the external memory. The discrepancy of the processing speed between the bus and buffer memories (11, 12), from that between the buffer memories (11, 12) and external memory can be smoothed out by temporarily storing the data in the buffer memories (11, 12).

It is also possible to arrange such a configuration that the data storage position into the buffer memories (11, 12) and data storage position into the external memory can be controlled from an apparatus on the bus side, or that the data storage position is automatically controlled from the memory control apparatus. When it is controlled from the bus side, it is preferred to make such arrangements that the leading address and data size at the storage position are set and one setting is sufficient for each data size. When automatic control is used, control and management will be facilitated if data can be taken out in the chronological order.

The memory control apparatus is compatible with both the read and write operations, or either the read or write operation.

It is sufficient if the buffer memories (11, 12) have a higher speed than the external memory, and it is preferred that they have such a processing capacity that a wait cycle will not occur with respect to access from other devices on the bus. In this case, the buffer memories (11, 12) may have any storage capacity. If access from the bus is continuously made in units of a predetermined amount of data, the storage capacity is preferred to be equal to or greater than one unit of the amount of data in continuous transfer.

Any type of the bus can be used. For example, a general-purpose bus such as a PCI bus (Peripheral Component Interconnect bus) can be utilized.

The memory connected to an external device can be of any type and any storage capacity. The data transfer section (14) is preferred to have an address space capable of covering the memory of the maximum capacity that can be connected.

In the present invention, the buffer memories (11, 12) and data transfer section (14) are provided for each of writing and reading. In response to the write access from the bus, the virtual memory space control section (13) writes the data on the bus, into the write buffer memory 11, and in response to the read access from the bus, the virtual memory space control section (13) reads the data from the read buffer memory 12, hence the data is sent to the bus.

According to the present invention, the write data transfer section (14) is exclusively used to transfer data to the external memory from the write buffer memories (11, 12), and the data transfer section (14) is exclusively used to transfer data to the read buffer memories (11, 12) from the external memory. Parallel execution of these transfer operations is enabled to the extent that access to the memory can be arbitrated. Further, the buffer memories (11, 12) are provided independently of each other for the read and write operations. This arrangement allows the FIFO (first-in/first-out) memory to be used for each of the buffer memories (11, 12) while compatibility with both the read and write operations is maintained, with the result that control is simplified.

This invention is characterized in that the buffer memories (11, 12) are FIFO memories.

The invention eliminates the need of address management with respect to the buffer memories (11, 12) and simplifies the internal configuration of the memory control apparatus.

The present invention is characterized in that the data transfer section (14) receives from the bus the setting of the leading address of the memory in transfer operation and the size of the data to be transferred, and data is transferred between the memory and buffer memories (11, 12), according to this setting.

According to the invention, the leading address of the memory in transfer operation and the size of the data are set from the apparatus on the bus side. This arrangement allows the data storage position in the external memory to be managed by the apparatus on the bus side. Further, if the leading address and data size are set, the data in the amount corresponding to data size can be transferred in one setting. This configuration reduces the number of settings and the load of the apparatus on the bus side.

### BRIEF DESCRIPTION OF THE DRAWINGS

FIG. 1 is a block diagram representing the configuration and connection status of a memory control apparatus as an embodiment of the present invention;

FIG. 2 is an explanatory diagram showing the relationship between the processing time on the bus side and that on the memory side, when a predetermined amount of data is transferred to the memory, using the memory control apparatus as an embodiment of the present invention;

FIG. 3 is a block diagram representing an example of the system configuration for transferring data, using the memory control apparatus as an embodiment of the present invention;

FIG. 4 is a block diagram showing the method for connecting the memory to the bus;

FIG. 5(a) is an explanatory diagram showing the relationship between the data transfer capacity of the bus and the processing capacity of the memory;

FIG. 5(b) is an explanatory diagram showing the relationship between the data transfer time of the bus and processing time required on the bus side; and

FIG. 6 is an explanatory diagram showing an example of a wait cycle being inserted into the bus by accessing the memory having the processing capacity lower than the data transfer capacity of the bus.

### DETAILED DESCRIPTION OF THE PREFERRED EMBODIMENT

Referring to the drawings, the following describes the preferred embodiment of the present invention:

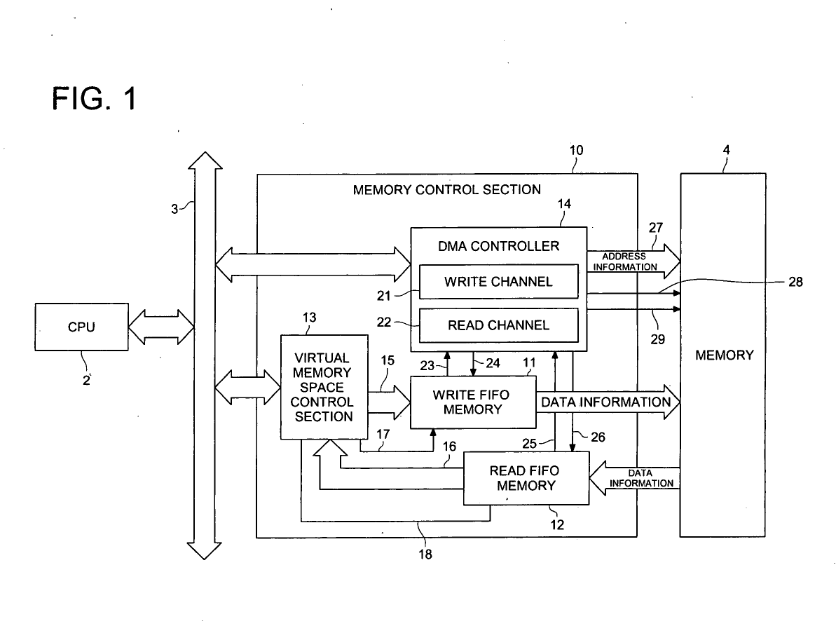

FIG. 1 shows the configuration and connection status of a memory control apparatus 10 of the present invention. The memory control apparatus 10 is connected between a bus 3 linked with a CPU 2, and a memory 4. The memory control apparatus 10 virtually serves to increase the speed of the memory 4. Here the bus 3 is a PCI bus, and the memory 4 is composed of a mass storage SDRAM (Synchronous Dynamic Random Access Memory). There is no restriction to the type of the bus 3 or memory 4.

The memory control apparatus 10 is composed of a write FIFO memory 11, a read FIFO memory 12, a virtual memory space control section 13 and a DMA controller 14.

The write FIFO memory 11 and read FIFO memory 12 have a higher speed and a smaller capacity than the memory 4, and serves to smooth out the discrepancy between the speed of access from the bus 3 and the processing speed. It consists of a 64-stage shift register having the same bit width as the path width of the bus 3, and operates as a FIFO (first-in/first-out) memory. The FIFO is the method whereby data items are read out in the chronological order. The last stored data item is the last data item to be read out.

The storage capacity of the write FIFO memory 11 and read FIFO memory 12 is not restricted to the storage capacity. In this case, it is set to the storage capacity equivalent to the maximum amount of data that is accessed on a continuous basis from one of the devices on the bus 3 side. In the PCI bus, the time period is specified when one device can occupy the bus on a continuous basis. The storage capacity of the write FIFO memory 11 and read FIFO memory 12 is set to the maximum amount of data that can be transferred within during the time when the bus can be occupied.

The virtual memory space control section 13 serves the function of converting the access from the bus 3 to a predetermined virtual address space, into the access to the write FIFO memory 11 or read FIFO memory 12. The virtual memory space control section 13 is connected with the address bus and data bus of the bus 3. The virtual memory space control section 13 is connected with each of the write FIFO memory 11 and read FIFO memory 12 through the data signal lines 15 and 16.

The virtual memory space control section 13 sends a write timing signal 17 indicating the data capturing timing on the data signal line 15, to the write FIFO memory 11. It also sends the read timing signal 18 indicating the data read timing, to the read FIFO memory 12.

When the write access to the virtual address space from the bus 3 has been detected, the virtual memory space control section 13 serves the function of writing the data on the bus 3, into the write FIFO memory 11. When there is a read access to the virtual address space from the bus 3, it reads data from the read FIFO memory 12 and sends it to the data bus of the bus 3.

When there is a write access to the virtual address space from the bus 3, the virtual memory space control section 13 and when there is no available storage space for storing the data in the write FIFO memory 11, the virtual memory space control section 13 sends a wait signal to the bus 3 until an available space is formed. In the similar manner, if there is a read access to the virtual address space from the bus 3, and the read FIFO memory 12 does not contain any data that can be read out, then a wait signal is sent to the bus 3 until the data that can be read out is provided. When the wait signal has been sent, a wait cycle is inserted in the bus in response to the wait signal.

The DMA controller 14 services the function of transferring data among the write FIFO memory 11, read FIFO memory 12 and memory 4. The DMA controller 14 has two data transfer sections; one is a write channel 21 that transfers data to the memory 4 from the write FIFO memory 11, and other is a read channel 22 that transfers data to the read FIFO memory 12 from the memory 4.

The write FIFO memory 11 sends a residual data volume information 23 for indicating the residual amount of the readable data stored therein, to the write channel 21 of the DMA controller 14. The residual data volume information 23 is outputted when readable data in the write FIFO memory.11 is present; it is not outputted if there is no readable data therein. The write channel 21 sends a FIFO read timing signal 24 for representing the data readout timing, to the write FIFO memory 11.

The read FIFO memory 12 sends available storage space information 25 indicating the available data storage space to the read channel 22 of the DMA controller 14. The read FIFO memory 12 outputs the available storage space information 25 if any, and does not output it if it is absent. The read channel 22 sends a FIFO write timing signal 26 to the read FIFO memory 12, wherein the FIFO write timing signal 26 indicates the timing of capturing the data read out of the memory 4.

The DMA controller 14 receives the setting from a device (e.g. CPU 2) on the bus 3, wherein this setting is related to the leading address of the data to be transferred, inside the memory 4, and the size of the data to be transferred, for each of the write channel 21 and read channel 22. After completion of the setting, it receives an instruction for starting the transfer operation from the device on the bus 3, it performs the data transfer operation according to the setting. When performing the data transfer operation, the DMA controller 14 sends the address information 27, actual memory write timing signal 28 for indicating the timing of writing the data, and actual memory read timing signal 29 for indicating a request to read data, to the memory 4.

The data transfer operation via the write channel 21 and read channel 22 is carried out asynchronously with access to the virtual address space from the bus 3. Further, during parallel operations of the write channel 21 and read channel 22, these operations are arbitrated with each other.

The following describes the flow of operations when the CPU 2 writes the data into the memory 4 through the memory control section 10. The CPU 2 ensures that the size of the data to be transferred and the leading address (in the actual memory address space) thereof in the memory 4 are set on the write channel 21 of the DMA controller 14, and a transfer operation execution instruction is set on the write channel 21.

Since data is not stored in the write FIFO memory 11 at first, the residual data volume information 23 is not outputted, and the write channel 21 waits for the output of the residual data volume information 23.

When the CPU 2 has transferred data to the virtual memory space, the virtual memory space control section 13 detects that the there is a write access to the virtual memory space from the bus 3, captures the data on the bus 3, and writes it in the write FIFO memory 11. To put it in greater details, the virtual memory space control section 13 sends the data captured from the bus 3, to the data signal line 15, and produces the overall control section 17 under this condition. When the overall control section 17 has been inputted, the write FIFO memory 11 captures the data on the data signal line 15 and loads it inside. When storing of the readable data is enabled, the write FIFO memory 11 outputs the residual data volume information 23.

When the residual data volume information 23 is inputted, the write channel 21 recognizes that the data to be read is loaded in the write FIFO memory 11. Then it sends address information to the memory 4, outputs the FIFO read timing signal 24, and reads the data from the write FIFO memory 11. While the data is read out of the write FIFO memory 11 the actual memory write timing signal 28 is outputted and the data is written in the area inside the memory 4 indicated by the preceding address.

Data is consecutively written into the write FIFO memory 11 from the bus 3 at the speed conforming to the processing capacity of the write FIFO memory 11, while data is transferred to the memory 4 from the write FIFO memory 11 at the speed conforming to the processing capacity of the memory 4.

The following describes the operation when the CPU 2 reads data from the memory 4 through the memory control section 10. The CPU 2 ensures that the size of the data to be read and the leading address (on the actual memory address space) in the memory 4 are set on the read channel 22 of the DMA controller 14. Then the CPU 2 sends the transfer operation execution instruction to the read channel 22.

The read channel 22 sends the address information and actual memory read timing signal 29 to the memory 4. In response of the data having been read out of the memory 4, it also sends the FIFO write timing signal 26 to the read FIFO memory 12, and consecutively writes the data read out of the memory 4, into the read FIFO memory 12.

When data should have been stored in the read FIFO memory 12, the CPU 2 accesses the virtual memory space control section 13 and reads out the data. Thus, the data stored in the read FIFO memory 12 can be read at the processing capacity (speed) of the read FIFO memory 12. For example, in response to the time when the read FIFO memory 12 has been filled, the CPU 2 should access the read FIFO memory 12 to read out data corresponding to its storage capacity on a continuous basis.

In the case of a PC1 bus, continuously available bus time is controlled. Thus, before the CPU 2 makes further access to the memory control section 10, the read operation is performed from the memory 4 to the read FIFO memory 12. The read FIFO memory 12 is filled with a sufficient amount of data by the time the CPU 2 reads the virtual memory space and gains access.

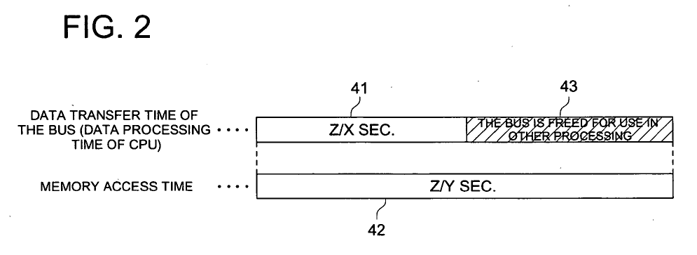

FIG. 2 shows the relationship between the processing time on the bus 3 side and that on the memory 4 side, when a predetermined amount of data is transferred to the memory 4, using the memory control apparatus 10. FIG. 2 is based on the assumption that the data transfer capacity on the bus 3 side and the processing capacity of the write FIFO memory 11 is X bytes per second, the processing capacity of the memory 4 is Y bytes per second, and the amount of data to be transferred is 2 bytes.

The bus 3 writes data into the write FIFO memory 11, so the processing of transfer 41 on the bus side terminates in Z/X seconds, without a wait cycle being inserted. In the meantime, the processing of transfer 42 on the actual memory side is Z/Y seconds; thus, for the bus 3 side, the speed of the memory 4 is virtually increased by the difference 43. The bus 3 is freed from the processing of transfer in Z/X seconds. This allows the subsequent time 43 to be used for other processing, and hence improves the efficiency of using the bus 3 and avoids deterioration of system throughput.

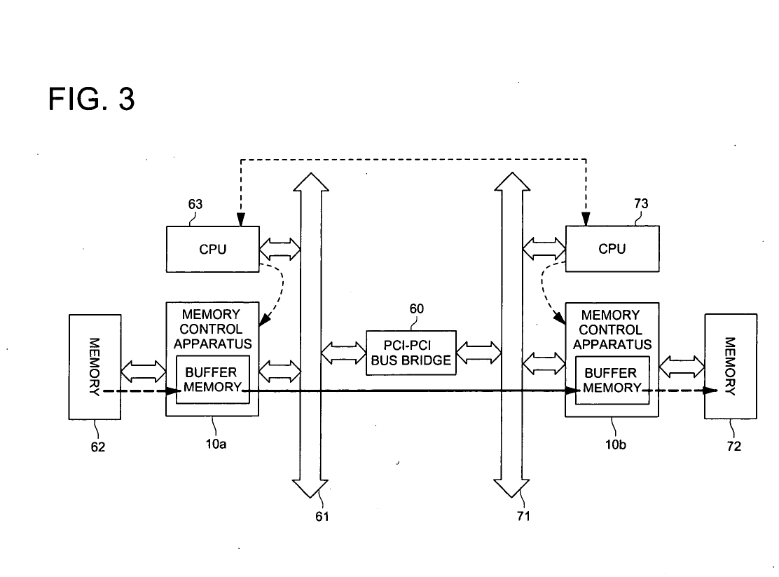

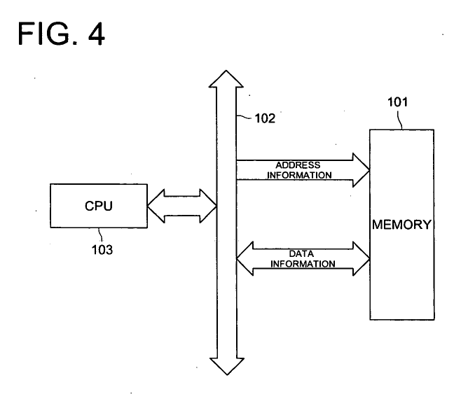

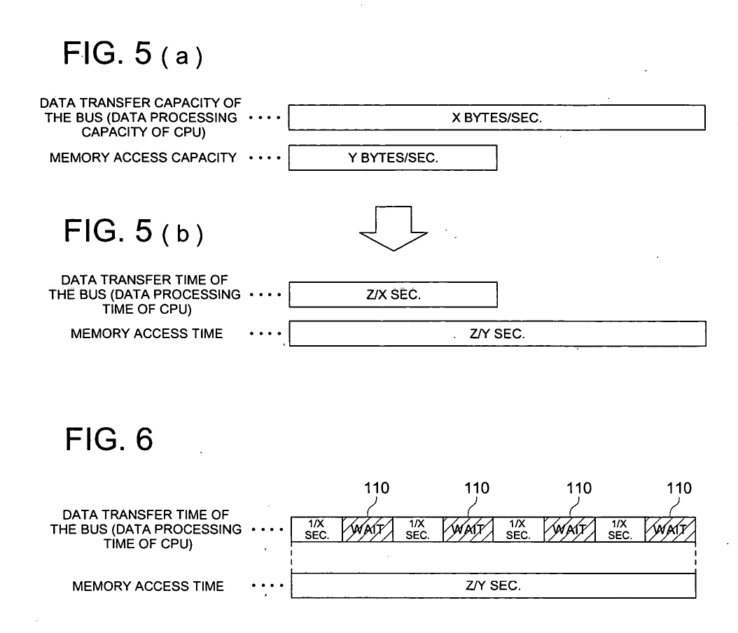

FIG. 3 shows an example of the system configuration for transferring data, using the memory control apparatus 10. In this system, data is DMA-transferred to the memory 72 connected to the second PCI bus 71, from the memory 62 connected to the first PCI bus 61 via the memory control apparatus 10a.

Data is transferred from the memory. 62 on the first PCI bus 61 to the memory 72 of the second PCI bus 71. In this case, the CPU 63 on the first PCI bus 61 and the CPU 73 on the second PCI bus 71 exchange necessary data to provide the following setting: The CPU 63 on the first PCI bus 61 ensures that the leading address (address of the data transfer source) inside the memory 62 of the data to be read, and the size of the data to be transferred are set in the memory control apparatus 10a, whereby the transfer operation is activated. The CPU 73 on the second PCI bus 71 ensures that the leading address (address of the data transfer source) inside the memory 72 in the data storage area and the size of the data to be transferred are set in the memory control apparatus 10b, whereby the transfer operation is activated.

The CPU 63 and CPU 73 set a bus bridge 60 in such a way that the data of the set data size is transferred to the virtual address space of the memory control apparatus 10b on the second PCI bus 71, from the virtual address space of the memory control apparatus 10a on the first PCI bus 61, and the operation is started.

The memory control apparatus 10a on the first PCI bus 61, the bus bridge 60 and the memory control apparatus 10b on the second PCI bus 71 operate in cooperation with one another to send data from the memory 62 to the memory 72. After startup of the operation, the CPU 63 and CPU 73 do not take part in the transfer operation, and can be used for other processing.

The embodiments of the present invention have been described with reference to drawings, but the specific configuration of the present invention is not restricted to the description given in the embodiments. The present invention included variations with appropriate modification or additions, without departing from the technological spirit and scope of the invention claimed. For example, in the above description, the buffer memory in the memory control section 10 is arranged according to the FIFO method; however, a memory based on other method such as the one requiring the address information may be used.

According to the memory control apparatus of the present invention, a low-speed memory is converted into a virtually high-speed memory. This eliminates the need of inserting a wait cycle at the time of access to the memory, and improves data transfer efficiency and bus usage efficiency, thereby increasing overall speed of the system using this bus. Further, the system performance is not deteriorated when a low-speed memory is utilized. This arrangement allows the apparatus cost to be cut down by using a less costly low-speed memory as a large-capacity storage section.

A buffer memory and a data transfer means are provided for each of the read and write operations. For example, by presetting the execution instruction for both the data transfer from the write buffer memory to the external memory and data transfer from the external memory to the read buffer memory, the operation can be performed through appropriate switching between the read/write operations from the bus, without having to change the instruction for the data transfer means each time.

In a system using a buffer memory and FIFO method, there is no need of address management of the buffer memory, and the internal structure of the memory control apparatus is simplified.

In a system wherein the leading address of the memory and data size in data transfer are set on an apparatus on the bus side, data storage position in the external memory can be managed by the apparatus on the bus side. Further, one setting of the leading address and data size allows the data equivalent to that size to be transferred. This arrangement reduces the number of settings, and hence reduces the loads on an apparatus on the bus side related to setting.

1. A memory control apparatus located between a bus and a memory, comprising:
a buffer memory having a higher speed processing and smaller capacity than the memory;
a virtual memory space control section for converting the access to a predetermined virtual address from the bus into the access to the buffer memory, for transferring data between the memory and the buffer memory; and
a data transfer section for transferring data between the buffer memory and the memory, asynchronously with the access to the virtual address space.

2. The memory control apparatus of claim 1, wherein the buffer memory having a write buffer memory and a read buffer memory, and the virtual memory space control section writes the data into the write buffer memory from the bus, in response to the write access from the bus, and reads the data from the read buffer memory, in response to the read access from the bus, transfers the data to the bus.

3. The memory control apparatus of claim 1, wherein the buffer memory is FIFO memory.

4. The memory control apparatus of claim 1, wherein the data transfer section receives the setting data of the leading address of the memory in transfer and the size of the data for transferring from the bus, and transfers between the memory and buffer memory based on the received setting data.

5. The memory control of apparatus of claim 1, further comprising:
a detect section for detecting a write access to the virtual memory space from the bus.
